(19) United States
(12) Patent Application Publication
(10) Pub. No.: US 2004/0008180 A1
(43) Pub. Date: Jan. 15, 2004

(54) Method and apparatus for effecting a presentation

(76) Inventor: Thomas C. Appling III, Palm Desert, CA (US)

Correspondence Address: PATTON BOGGS LLP, ATTORNEYS AT LAW, 2550 M Street, NW, Washington, DC, 20037-1350, US

(21) Appl. No.: 10/158,018

(22) Filed: May 31, 2002

(51) Int. Cl. G09G 5/00

(52) U.S. Cl. 345/156

(57) ABSTRACT

A method is provided for playing a presentation. The method displays, through a display device connected to a machine, information identifying a presentation background, music, and presentation effects. The method receives a presentation selection including information identifying the presentation background, the music, and/or the presentation effects. The method then plays, through the display device, a presentation reflecting the selected information. The machine is a data storage drive, a printer, or a docking station, and includes a processor and a memory. The processor is configured to effect the presentation, whereas the memory is configured to store information representing the presentation background, the music, the presentation effects, and the presentation.

### FIELD OF THE INVENTION

The present invention relates to multimedia systems. More particularly, the present invention relates, for example, to effecting a music video presentation.

### DESCRIPTION OF BACKGROUND INFORMATION

Presently, people are taking pictures with many different types of cameras, from Polaroids to digital cameras, and they are finding that categorizing, storing, displaying, and sharing images is becoming increasingly tedious. People are also recognizing that photo albums simply do not provide a truly stimulating and efficient way to categorize, store, and display photographs. Photo albums, for example, support print pictures, but do not support other types of pictures such as digital images.

New ways of viewing and manipulating images, however, are currently being developed, for example, by companies such as Kodak, Roxio, PhotoMusicVideo.com, ShockWave.com, Printlife, and Ceiva Networks. These companies, unfortunately, all require users to interface, in some fashion, with a multimedia personal computer system in an attempt to enhance the user photographic experience. As a result, these new ways of viewing and manipulating images are, in effect, being made unavailable to non-computer users.

Systems depended on a multimedia personal computer, peripheral components (e.g., printed document scanner, CD/DVD burner, modem, and color printer) and additional software to effect music videos, are not economically priced and thus are economically out of reach of the majority of potential users. In addition, most people are unwilling and/or unable to spend the long hours required to learn to operate the technically complicated system of the multimedia personal computer, the peripheral components, and additional software. Furthermore, even users that are willing to spend the time and money to master their multimedia personal computer system must be prepared to spend a substantial amount of time producing their own videos. Accordingly, there exists a need for a method and/or apparatus that allows users, for example, to categorize, store, view, and share pictures and/or effect videos in cheaper, faster, and better ways.

### SUMMARY OF THE INVENTION

In one implementation of the present invention, a method is provided for playing a presentation. The method displays, through a display device connected to a machine, information identifying a presentation background, music, and presentation effects. The method receives a presentation selection including information identifying the presentation background, the music, and/or the presentation effects. The method then plays, through the display device, a presentation reflecting the selected information. The machine is a data storage drive, a printer, or a docking station, and includes a processor and a memory. The processor is configured to effect the presentation, whereas the memory is configured to store information representing the presentation background, the music, the presentation effects, and the presentation.

### BRIEF DESCRIPTION OF THE DRAWINGS

In the drawings, like reference numerals represent similar parts of the illustrated embodiments of the present invention throughout the several views and wherein:

FIG. 1 is one embodiment of a machine;

FIG. 2 is another embodiment of the machine of FIG. 1, including a docking station for a camera;

FIG. 3 is the docking station and the camera of the embodiment of FIG. 2;

FIG. 4 is one embodiment of a navigational flowchart;

FIG. 5 illustrates exemplary data input to and data output from a machine;

FIG. 6 is one embodiment of a three act process;

FIG. 7 is another embodiment of a three act process;

FIG. 8 is one embodiment of a five act process;

FIG. 9 is one embodiment of a four act process;

FIGS. 10-14 illustrate embodiments of a graphical user interface;

FIGS. 15-16 illustrate embodiments of a data set containing music, background, and special effects;

FIG. 17 illustrates a simplified diagram of network communications;

FIG. 18 is one embodiment of a method for network communications;

FIG. 19 is one embodiment of a method for machine-to-machine communications;

FIG. 20 is one embodiment of a method to develop and/or download photographs through network communications;

FIG. 21 is one embodiment of a method to effect a presentation;

FIG. 22 is one embodiment of a method to send a presentation theme to a user of the machine of FIGS. 1 and 2; and

FIGS. 23 and 24 illustrate embodiments of the machine of FIGS. 1 and 2.

### DETAILED DESCRIPTION

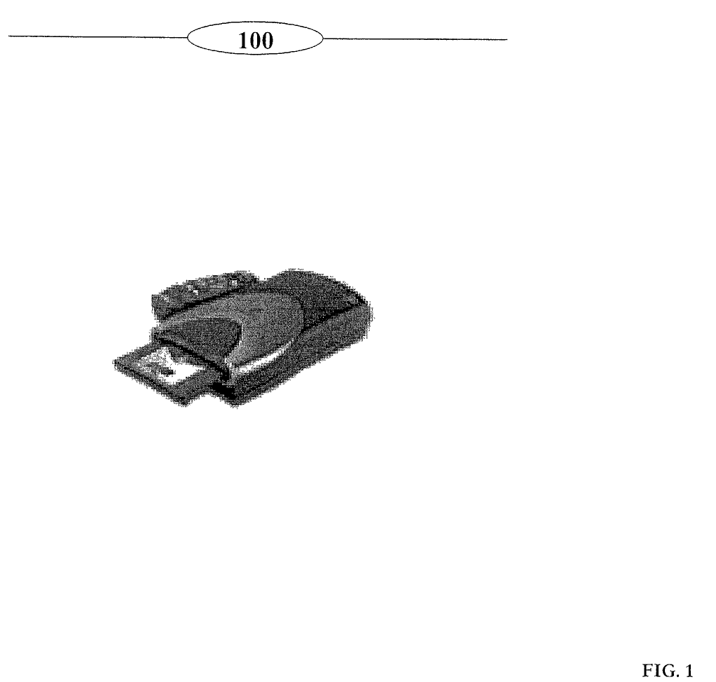

FIG. 1 illustrates an embodiment of a machine 100 (e.g., a data storage drive such as, for example, a multimedia hard drive). The machine 100 may allow virtually anyone to create, for example, music videos from photographs and/or music. The machine 100 is user friendly and within the capabilities of virtually any person. The machine 100 allows a user to tell, through a television, and memorialize a story of a special occasion(s) captured in pictures, and/or to view photographs (e.g., hundreds of photographs in minutes). The machine 100 allows a user to organize (e.g., organize in folders), name, enhance, compress, store, search, retrieve, resize, adjust, and/or play photographs, music, and/or music videos, by himself or herself or with others.

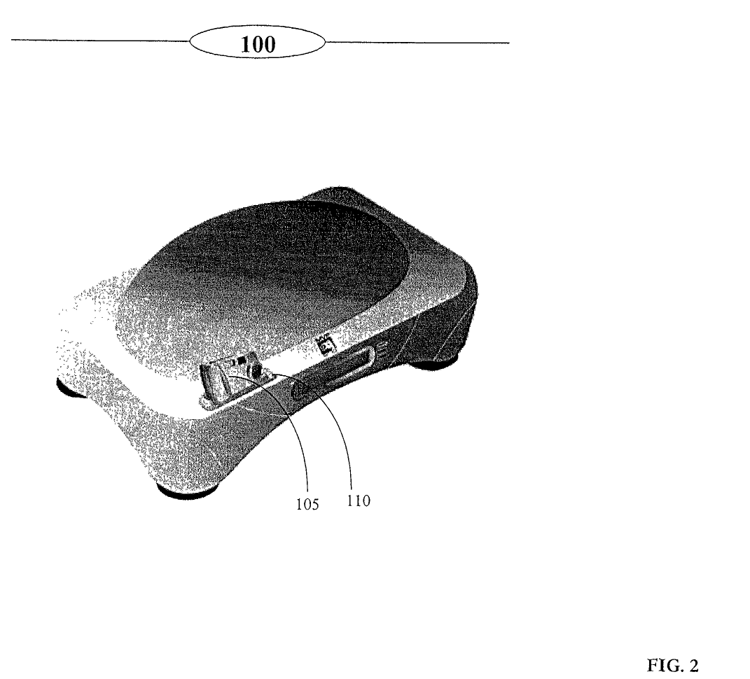

The user may scan his or her photographs, through the machine 100 (see, for example, FIG. 2), and choose an output format such as, for example, DVD, CD, VHS, zip disk, email, etc. for his or her music video. The machine 100 produces an “end-product” (e.g., multimedia presentations) that the user can share (e.g., distribute) with friends and family. The machine 100 may also include up to 40 gigabytes or more of data storage for the user's photographs, music videos, etc., and the ability to playback, for example, without the need of a digital camera and/or a multimedia personal computer. The machine 100 allows the user to use an unlimited number of photographs to make his or her own music video(s).

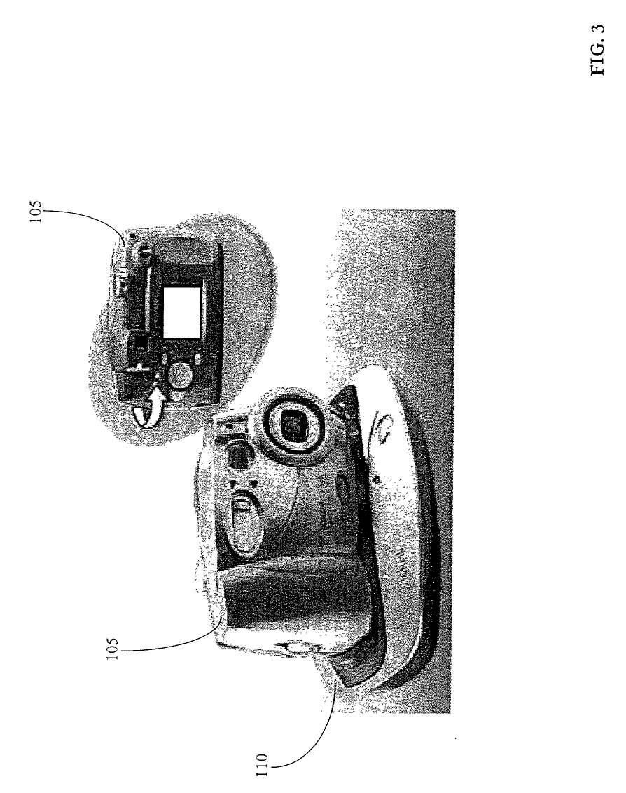

FIG. 2 illustrates an embodiment of the machine 100 including a docking station 110. The docking station 110 is constructed and arranged to couple a (digital) camera 105 to the machine 100 and/or to a display device (not shown). The digital camera 105 may be Kodak's DX3600 zoom digital camera (see FIG. 3). The digital camera 105 may be docked, through the docking station 110, to the machine 100 and/or to a display device (not shown). The machine 100 includes the ability to detect, for example, the active camera USB connection to the machine 100. The machine 100 may charge the camera while docked in the docking station 100. The machine 100 may also include the ability to load any and all photographs on the digital camera into the machine 100. The machine 100 then allows the user a place (i) to store the digital camera 105, (ii) to store (digital) images, through a single action (e.g., one-click) by the user, (iii) to enhance, (iv) view and/or (v) print photographs. The photographs may also be integrated into a presentation and/or saved to a data storage drive (e.g., hard drive).

The user may simply insert the digital camera 105 into the docking station 110 after using the camera. The user then turns on the machine 100, and, in turn, the machine 100 auto-senses the digital camera 105. The user may “select photographs” from the digital camera 105 to auto-download into the machine 100, and display images, e.g., in a “thumbnail” view, through a display device. Also, the user may: (i) select a photograph to enhance, share and/or save, (ii) select a plurality of photographs to store and/or insert into a music video, and/or (iii) select to download a photograph(s) to save and/or insert into the music video. The machine 100 is capable to not only complete the user's photographic experience, but it also enables non-computer users and/or non-digital camera users the ability to effect powerful (multimedia) presentations in faster, cheaper, and better ways.

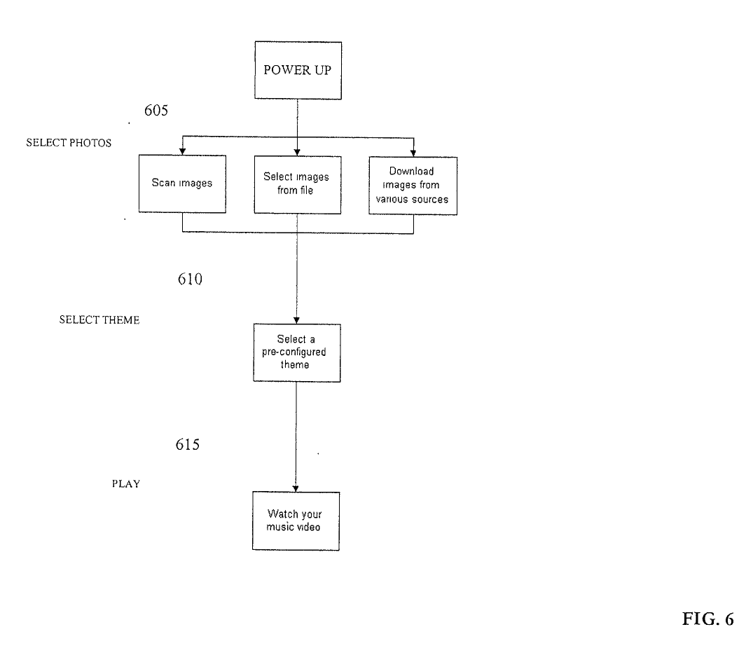

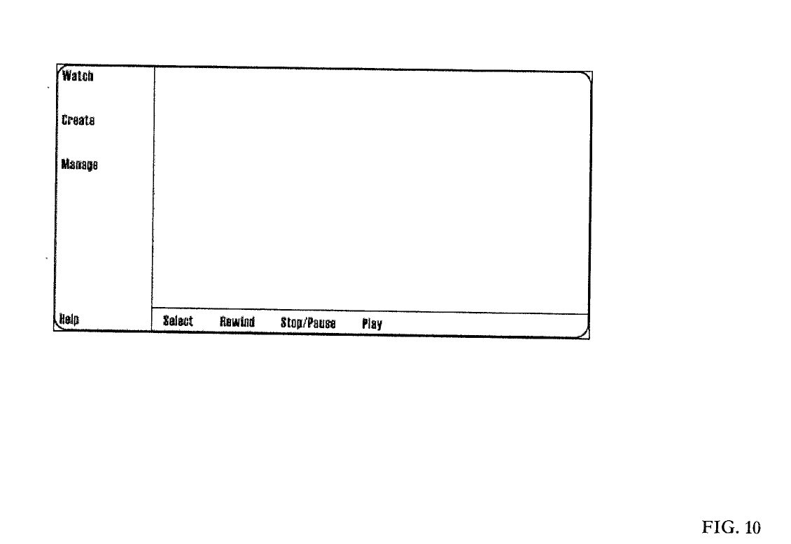

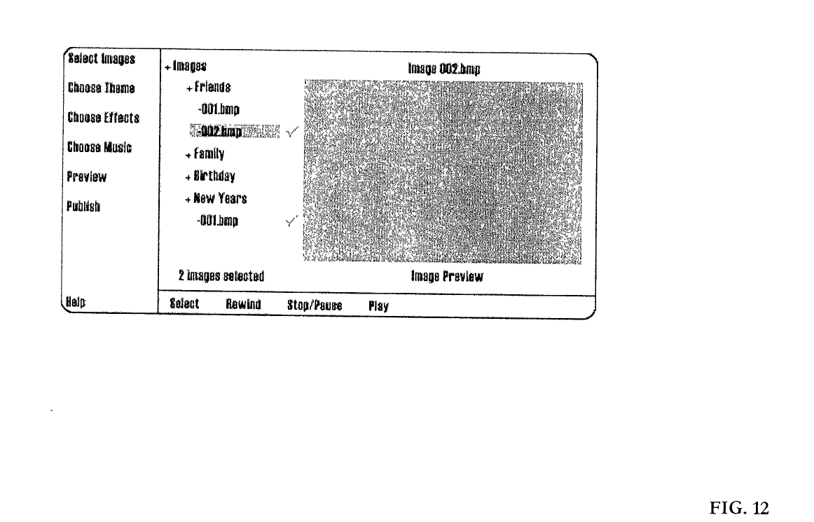

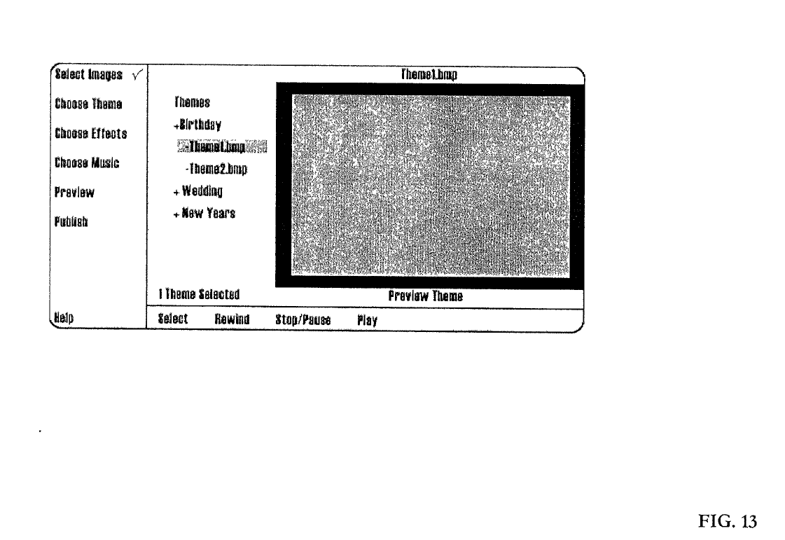

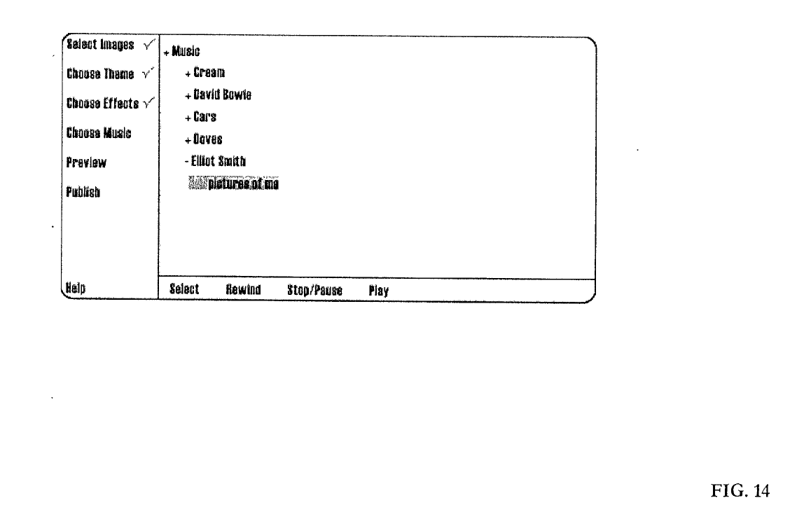

The machine 100 may be (directly) coupled (e.g. connected) to the display device (e.g., a television), where the music videos may be displayed. The machine 100 may be an autonomous system that is connected to the display device to be fully functional. The machine 100 may also be (directly) coupled (e.g. connected) to a network (e.g., Internet) to enhance the user's photographic experience. For example, the user may send and/or receive information (e.g., photographs, music videos, etc.) from a first machine to a second machine. The machine 100 also allows the user to send and/or receive e-mails. As explained below, the machine 100 further allows films once developed to be (automatically) downloaded thereto. The music videos may also be saved onto a DVD, CD, VCR, etc. The machine 100 may be (solely) dedicated to effecting the music videos, and may provide a user-friendly graphical user interface (“GUI”). The GUI may include simple menus and/or graphic icons, and/or additional options (see, for example, FIGS. 10-14). The GUI allows the user to create a presentation (e.g., a music video presentation) in three to five acts, from start to finish (see, for example, FIGS. 6-9).

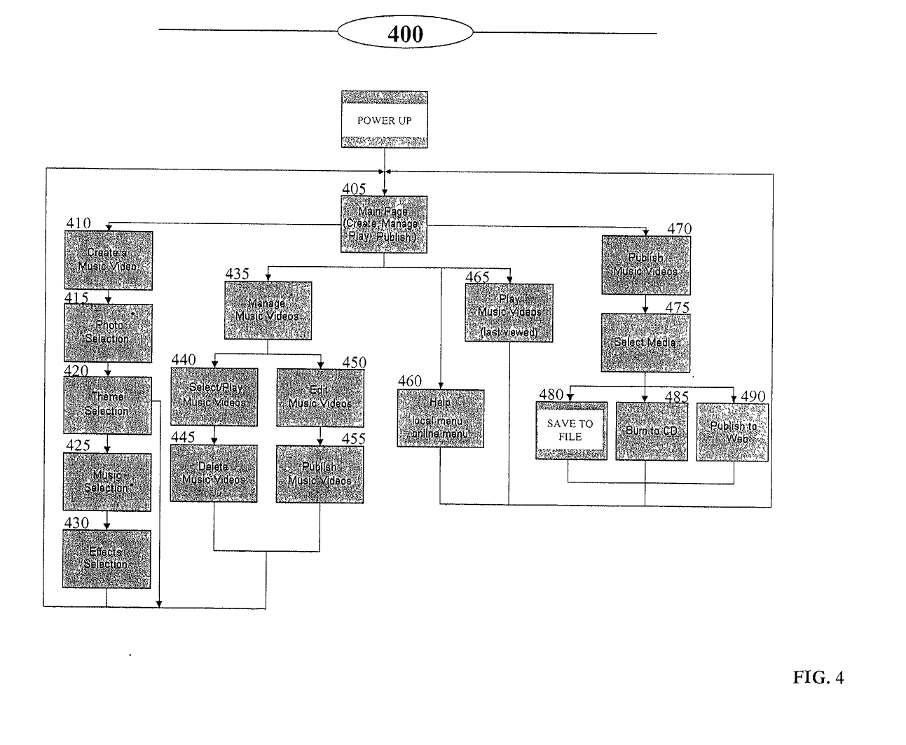

FIG. 4 illustrates an exemplary navigational flowchart 400 for the machine 100. The machine 100 may accept (digital and print) photographs, through scanning and/or downloading, and allows the user to choose the photographs, e.g., from photographs stored in the machine 100, a theme(s) (e.g., preset genre such as birthday, wedding, graduation, etc), a background (e.g., a static background), (special) effects/transitions scheme(s) and/or accompanying music. The user may also manage, play, and/or save its music video. The machine 100 allows the user to purchase the music (e.g., singles) and/or (video) themes, for download and/or playback.

The navigational flowchart 400 includes a main page 405 including an indication to: (i) create a music video 410, (ii) manage music videos 435, (iii) help 460, (iv) play music videos 465, and/or (v) publish music videos 470. To create the music video 410, the user may select: a photograph(s) 415, a background(s) 420, music 425, and (special) effects 430. The user may also select a (preset) theme 420 that includes a background, music, and/or effects. The user may play the created music video 465. To publish the music video, the user selects a machine-readable medium 475 such as, for example, (i) save to file 480, (ii) burn to CD 485, and/or (iii) publish to Web 490. To manage the music video(s) 435, the user selects a music video(s) 440, and/or delete the selected music video(s) 445. The user may also edit a music video(s) 450 and publish the edited music video(s) 455. In addition, the user may select an online and/or local help menu 460.

The detailed description then refers to the accompanying drawings that illustrate several embodiments of the present invention. Other embodiments are possible and modifications may be made to the embodiments without departing from the spirit and scope of the invention. Therefore, the detailed description is not meant to limit the invention. Rather the scope of the invention is defined by the appended claims, and their equivalents.

The machine 100 may include: a CD player/recorder; an MP3 player/recorder; a DVD player/recorder; a karaoke machine; a business presentation machine; a remote control; a keyboard; a mouse; a photo enhancer; motion video clips (e.g., avi, mpeg, mov); a storage device; a photograph retrieval machine to download photographs from film developing services; voice activation; touch-screen activation; CD labeling; network communications (e.g., automatic modem dialup); videoconferencing; and/or Web browser (e.g., a selective Web site browser). The Web browser may direct the user to a specific Web site that includes: software upgrades; music; presentation backgrounds; presentation (special) effects; presentation themes; demos; machine system checks; customer service; online store; data storage; chats; broadcast; private community networking; publisher; streaming service; and/or e-mail. The machine 100 itself may be assigned a specific identifier (e.g., ID) to be allowed accessed to a private community for users of the machine 100.

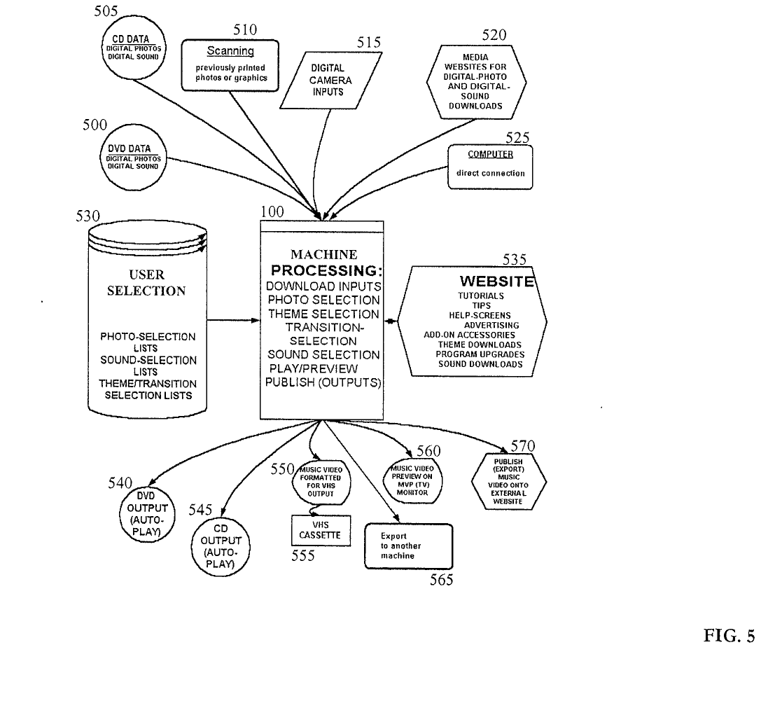

FIG. 5 illustrates exemplary data input to and data output from the machine 100. The data inputs include: (i) DVD data 500, (ii) CD data 505, (iii) scanned data 510 (e.g., print photographs), (iv) digital camera data 515, (v) Web site data (s) 520, and/or (vi) a multimedia personal computer 525. The data outputs include: (i) DVD data 540, (ii) CD data 545, (iii) VHS data 550, 555, (iv) display device data 560, (v) export data 565, and/or (vi) Web site data 570. The user presentation selections include: photographs, sound, background(s), (special) effects, and/or theme(s) 530. The machine 100 may include a Web site 535 to upload and/or download data (e.g., MP3 files).

The machine 100 may include a GUI configured to accommodate the user. The navigation, through the GUI, can be configured in the order of importance and/or most used of the machine's features. One embodiment of a GUI (see, for example, FIGS. 10-14) may include:

Tutorial

Simple Navigation:

Watch (Photo/Music) Video(s)

Create (Photo/Music) Video(s)

Manage (Photo/Music) Video(s)

Play/Preview/Publish

Help

Multi-file System

Help Screens

On-line Interface for Tutorials, Downloads, Orders, etc.

Tutorial

The GUI may include a tutorial screen(s) to create a (photo/music) video. The tutorial may be a short video showing sample screens of demo videos. With a single action (e.g., a simple keystroke), the user can bypass the tutorial screen to start effecting his or her photo music videos.

Simple Navigation

The intuitive, user-friendly GUI includes menus related to a user selection. The GUI may include a “Back to Main Menu” selection in case the user would like to return to the main screen. The menus may include:

Watch Photo Video(s)

Play

Stop

Rewind

Create Photo Video(s)

Select Images

Choose Theme

Choose Effects

Choose Music

Manage Photo Video(s)

Play/Preview/Publish

Help

Getting Started

Visit Website

Return to Main Menu

Watch Photo Video(s)

The GUI allows the user to watch videos, for example, by way of a “Watch Photo Video” menu, which may open up 3 menu buttons (see above). The user options include: play a video (e.g., chosen from a list), stop the video, and/or rewind the video. The stop button may double as a pause button in case the user would like to view an image for some time.

Create Photo Video(s)

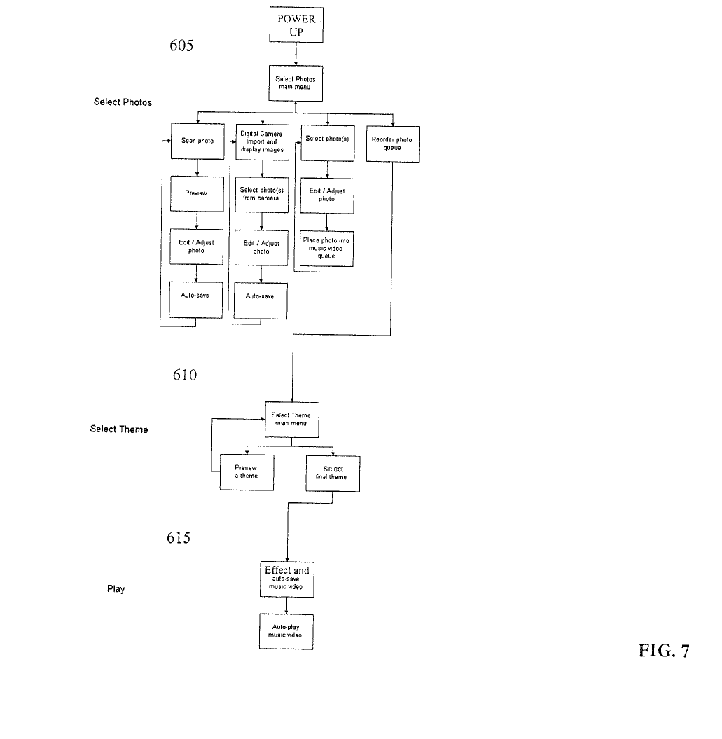

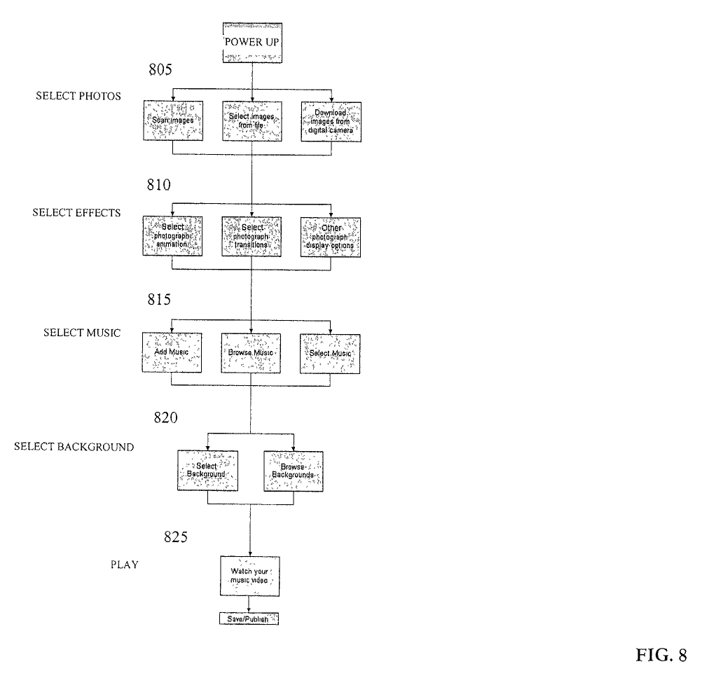

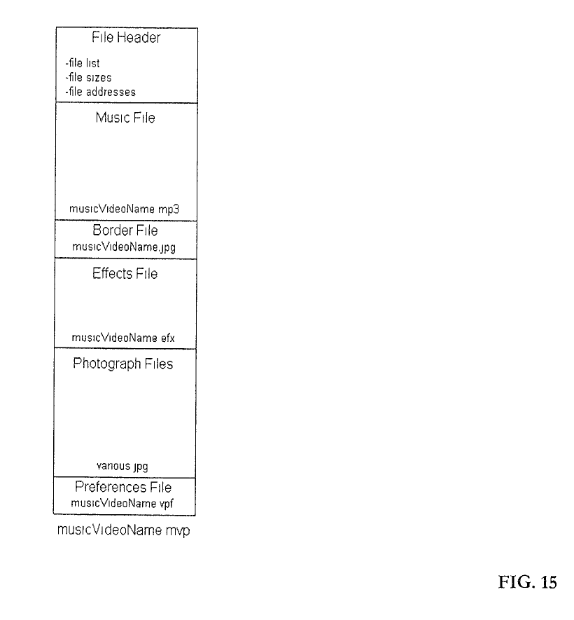

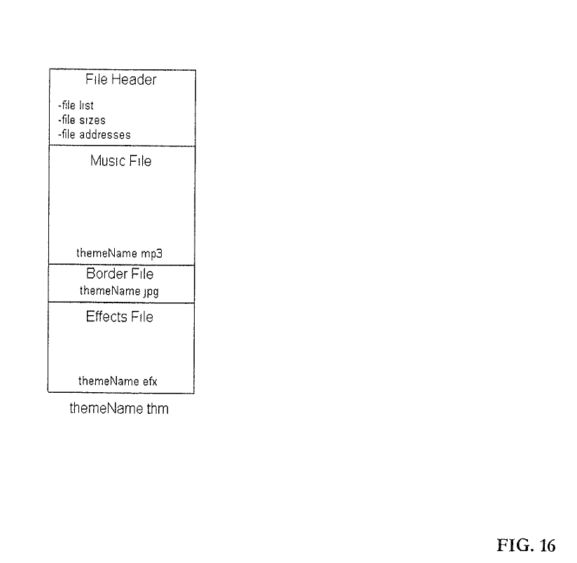

The machine 100 also allows the user to create a (music) video, for example, by using the GUI to gather information, from the user, through a user selection process. In operation, the machine 100 reads the assigned user variables, e.g., from a text file (see, for example, FIGS. 15-16), to effect the (music) video. The machine 100 may include a three (3) act process (see FIGS. 6-7) and/or a five (5) act process (see FIG. 8) to effect the video. Each process provides directions, for example, with graphic and/or text images to facilitate the user experience.

3 Act Process

The 3 act process includes “presets” that takes the guesswork out of selecting options to create a presentation. Predefined selections include a particular blend of music, background(s), and/or (special) effects. These preset themes include events such as, for example, birthdays, sporting events, family reunions, etc. Thus, in the 3 act process, the user selects, among others, images (e.g., photographs) 605, and theme(s) 610 to play his or her video 615 (see FIGS. 6-7).

5 Act Process

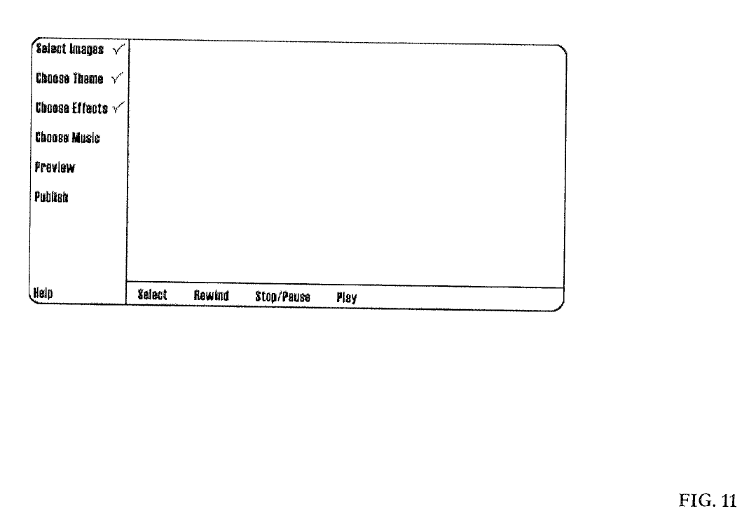

The 5 act process provides the user more control and creativity in creating his or her video. In the 5 act process, the user selects, among others, images (e.g., photographs) 805, (special) effects 810, music 815, a background(s) 820 to play and/or publish the video 825 (see FIG. 8). The images, the effects, the music and/or the backgrounds may be downloaded into and/or retrieved from the machine 100. The user selections may be made within the “Create Photo Video” window (see FIGS. 11-14), for example, by scrolling up and down, and by using select buttons for user choices.

Select Image(s)

The selection of image(s) may be made from folders containing a plurality of images. The order in which the images are to be played may be based, in whole or in part, by numbers included next to the name of the images (e.g., pictures) included in the video. Also, the order in which the images are to be played may be based on the order in which the images are selected to be included in the video.

Select Background(s)

The user may select a background(s) to reflect the type of video he or she wants to create. The background choices include: (i) none (e.g., blank); (ii) user selects own background (e.g., browse); (iii) photo album; (iv) picture frame; (v) personal portrait; (vi) special occasions (birthday, anniversary, weddings, funerals, etc); (vii) memories; and/or (viii) love.

Select Transition Effect(s)

The user may spice up its photo video with transitional effects that, for example, fade pictures in and/or out in unique ways. Effects may be downloaded from a Web site. An illustrative list of effects includes: (i) storybook; (ii) fade; (iii) kaleidoscope; (iv) turn pages; (v) pulsate; and/or (vi) flash.

Select Music

Also, the user is able to select music to add to his or her photo video, from a variety of sources such as, for example, retrieving music from the machine 100. The machine 100 may include a plurality of songs covering a wide spectrum of music genres. An exemplary list of genres include: pop, rock, alternative, country, jazz, lounge, world, R&B, folk/Country Western, dance, funk, instrumental, electronica, classical, and/or occasions. The occasions include birthday, new year, prom, sporting events, etc. The user may also download music from their own library of CDs, MP3s, WAVs and tapes into the machine 100. Also, the user may download music from the Web into the machine 100.

Select Theme(s)

Themes may be based, for example, on a genre, popular song and/or artist (e.g., group). A theme may be pre-packaged in a single (proprietary) file that contains the music, background (e.g., background images), picture inserts and (special) effects, designed specifically for the music (see FIGS. 15-16). The theme may include a predetermined set of variables forming a genre allowing the user to quickly define, build and play his or her own video(s). In the 3-act process, the user may scan his or her photos, select a theme and press play to play his or her own video. In addition, the user can create his or her own theme(s) or download “Specialty Themes,” through a network, for a wide variety of occasions.

The user's photo video(s) may reflect a top song(s) on the charts. As such, the user may also wish to select “New Artist Themes” to be include in his or her video. These custom themes from artists such as, for example, Marc Anthony, Destiny's Child, Dixie Chicks, Shakira may be purchased and/or downloaded into the machine 100 and added to a theme library to be available for immediate user selection. The user may then select his or her photographs to star with his or her superstar idol(s) in a music video.

Themes, which are available in the 3-act process, may be selected to produce a particular type of photo music video. Themes, however, do not have to be selected to produce a video. An illustrative list of themes include:

1. Photo Album/Life in Pictures

a. Genre: Family Oriented

b. Music: “From Within” by Lynnette

c. Background: Actual photo album (book)

d. Effects: Pages turning, must see faces

e. Speed: medium/slow

2. We are Family

a. Genre: Family Oriented

b. Music: “We are family” by Sister sledge

c. Background: Picture Frame

d. Effects: varied and modem but still see the faces

e. Speed: medium

3. Love

a. Genre: Love

b. Music: “All we need is Love” by Beatles

c. Background: Hearts, word “LOVE” in different languages

d. Effects: pulsating, exciting, lots of movement,

e. Speed: medium/slow

4. Kidz!

a. Genre: Kids: from 8-12yrs old

b. Music: “Arron's Party” by Arron Carter

c. Background: cartoon characters

d. Effects: Wild, exciting, lots of movement

e. Speed: fast

5. Vacation Getaway

a. Genre: Activities

b. Music: The Banana Boat Song, Harry Belafonte

c. Background: Sky, clouds, ocean, sun rays

d. Effects: various, movement, fin

e. Speed: medium

6. Celebrations/Special Occasions

a. Genre: Special Occasions

b. Music: “Celebration” by Kool & the Gang

c. Background: Streamers, fireworks, champagne & glasses

d. Effects: Wild, movement, flashy

e. Speed: medium/fast

7. In Memory of . . .

a. Genre: Funeral/memorial

b. Music: “Missing You” by Diana Ross

c. Background: graveyard, clouds, crosses, stained glass

d. Effects: dreamy, fades, kaleidoscope

e. Speed: slow

8. We are the Champions

a. Genre: Sports

b. Music: “We are the Champions” by Queen

c. Background: stadiums, crowds of people, colleague of sports equipment

d. Effects: fast, wild, stop motion, slides

e. Speed: medium/variable

9. Product Demo/MVP Kiosk

a. Genre: Business

b. Music: Voice over/Instrumental

c. Background: none

d. Effects: various standard slides, covers, wipes

e. Speed: slow

10. Intimate Portraits

a. Genre: Love

b. Music: “Ordinary Love” by Sade

c. Background: bedroom, lips, body parts

d. Effects: soft, blends, fades, zooms, various

e. Speed: slow

11. Thank You Lord

a. Genre: Spiritual

b. Music: “Thank You Lord” by Lynnette

c. Background: Christ, cross, clouds, doves

d. Effects: soften, blends, various fades,

e. Speed: medium/slow

Save/Publish/Burn to CD and/or DVD

The user may save the video creation on the machine's data storage assembly. For example, the machine 100 saves the user's selected settings for the photo video in a readable file. The file may be dated by a system clock. The photo video may also be published to a CD, VCR tape, and/or DVD, where the following may be copied thereto: image folder including images; settings folder including video settings; director player in .exe format; and/or autorun file to autoplay, for example, in a PC.

The user may choose multiple presentations and/or photographs from the machine's data storage assembly to burn onto a CD, VCR tape, DVD, etc. The machine 100 allows the user to

Choose files to burn

Select presentations

Select photographs

Help System

Help screens include helpful tips and problem-solving advice to enhance the user experience. Tutorials may be animated to guide the user through the photo-album creation process. The tutorials may include simple .avi and .mov animations of screenshots with text and/or audio. The help screens may also display questions and answers. Help may also be provided through a Web site that may be accessed anytime during the video creation process. The site may include demonstrations, questions and answers, and/or a description parts and features.

Scanning and Viewing

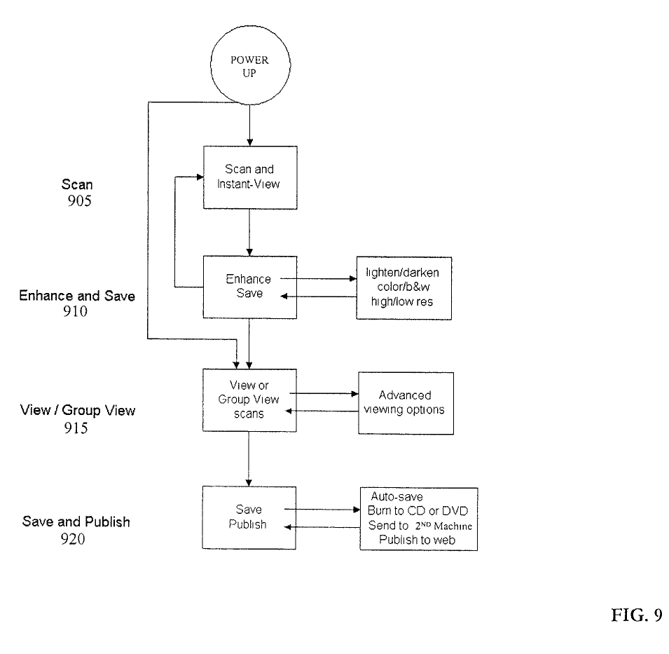

The machine 100 is constructed and arranged to be coupled (e.g., connected) to a display device (e.g., television, computer monitor, projector, etc.), and to be turned on to begin scanning and viewing images (see FIG. 9). The user may order and/or store the scanned images in the machine 100, onto a CD, and/or send them to others through a network. In addition, with a simple click of a button, the user may view a “photo enhanced” version of the scanned image. All this can be done in minutes, and thus saving the user lots of time and effort.

4 Act Process:

1. scan image 905,

2. choose to view 915, enhance 910, save 920 and/or continue to scan 905,

3. if “view” is chosen, and multiple images have been scanned, then group viewing may be an option 915, and/or

4. once viewing is completed, then save, publish, share, and/or burn to CD, DVD, etc. 920.

Additionally, the user can scan in any number of photographs and save them, for example, in jpg format on the machine's data storage assembly. In addition, the machine 100 allows the user to:

Preview scanner bed

Rotate image and/or image-selection (e.g., by 90 degrees)

Select area where photograph lies

Save photograph

Photograph enhancement—editing utilities

Lightening and darkening utilities

Cropping utilities

Resizing utilities

Drawing/typing utilities

Machine to Network Communications

The Internet is a well-known, global network of cooperatively interconnected computer networks. The World Wide Web (“Web”) portion of the Internet is a collection of server computers that store documents (e.g., Web pages), which are typically accessible by the public. A Web page consists of text, graphic, audio/visual, and the like (e.g., multimedia). The Web pages on the servers are identified by a Uniform Resource Locator (“URL”). An Intranet is similar to the Internet. Intranets, however, restrict access to the network to users outside of employees of a corporation. Hereinafter, any description of the Internet also is applicable to an Intranet.

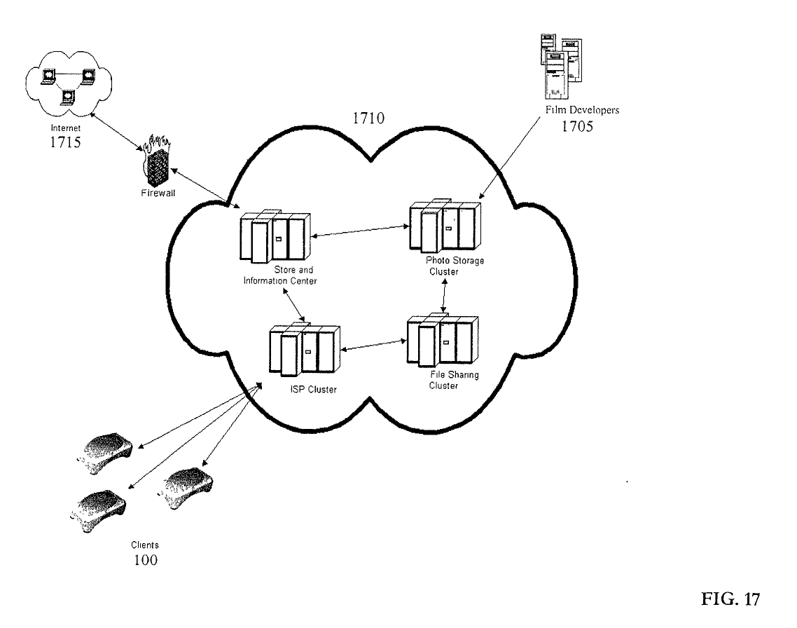

In a simplified illustration of network communications (e.g., FIG. 17), machines 100 connect to an Internet Service Provider (“ISP”) or a Network Service Provider (“NSP”) (not shown). The Internet Service Provider (“ISP”) provides Internet access to users of machines 100, while the Network Service Provider (“NSP”) provides Internet access to the ISPs, as well as users of machines 100. The ISP/NSP includes a router (not shown) that connects to servers through a network 1715 (e.g., Internet or Intranet). A browser, running on each of machines 100, retrieves (or downloads) Web pages from the servers. The browser allows the users of machines 100 to navigate (or “browse”) between Web pages.

The machine 100 may provide an automated online component to allow users to purchase products and/or services with a single action (e.g., a simple click of a button). The machine 100 may allow a user to log onto a pre-selected website(s), for example, to access special discounts and/or purchase products and/or services. For example, film developing services 1705 can download developed film directly into the machine 100 to eliminate the need for the user to find his or her receipt, pickup, and pay for the film.

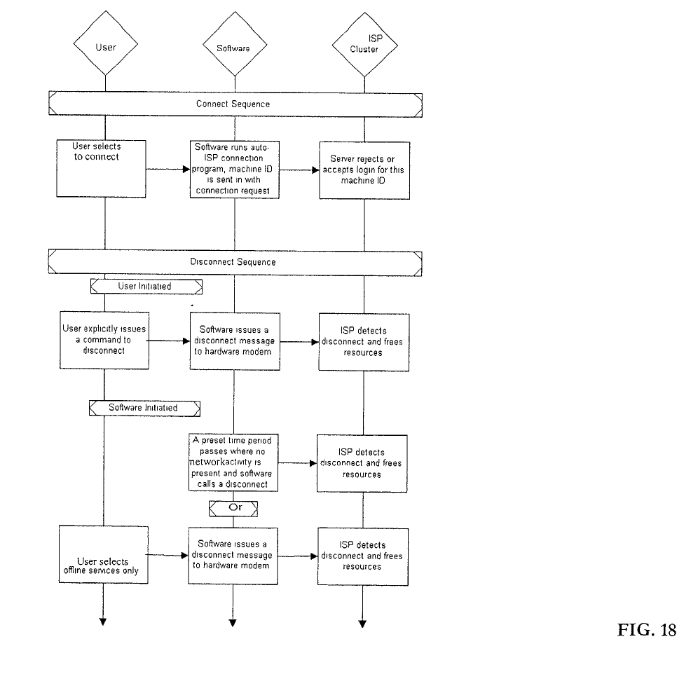

The machine 100 may automatically be setup (see FIG. 18) to download and charge an online account for music (e.g., a full version and/or a karaoke version of a song) and/or presentation themes, from a designated website(s). The cost of the downloaded music may be charged to and/or deducted from a user account. The machine 100 may automatically receive a notification of new releases of music and/or presentation themes.

The machine 100 may identify the user when first turned on, for example, to marry the machine 100 to the user. The machine 100 may be assigned a unique ID number, for example, used by a website to identify the machine 100. Once the user has entered his or her information, the website then identifies the user and/or the machine 100. The machine 100 may be configured to identify multiple users.

The machine 100 and the website communicate in a seamless way, for example, using a modem, auto dialer, auto logon script, etc. Once the machine 100 is turned on, it may activate a modem to dial a predetermined 800 number to connect, for example, to the film developing service 1705. Once connected the user may be presented with special offers to enhance the user experience. One such offer may be a film club. Film club members may receive special offers including free film and/or discounts on film development. By using this feature members may no longer have to go to the store for film and/or film development.

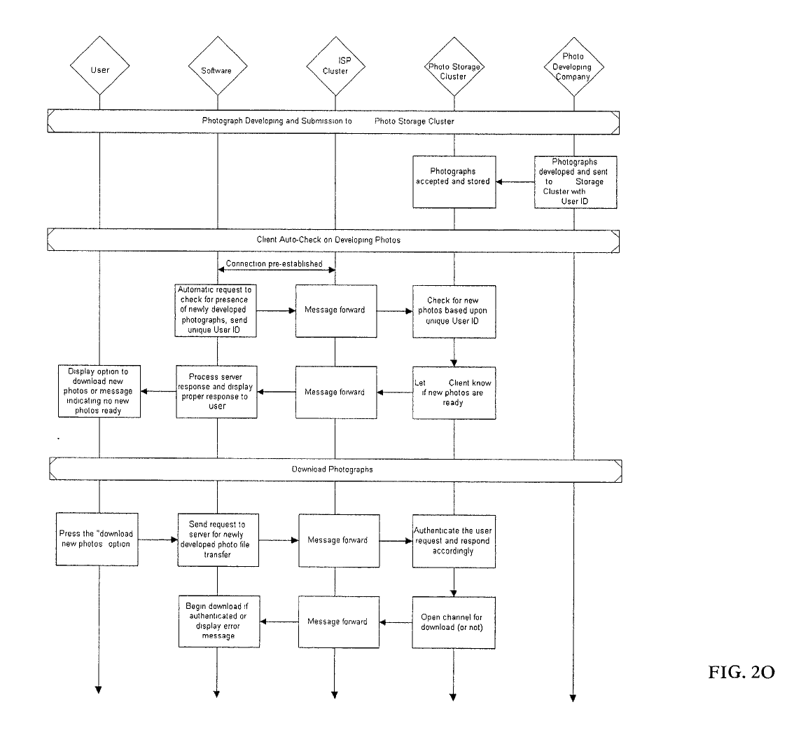

After the user exposes the film, he or she can drop it into any mailbox for processing. Film/cameras may be specially marked with the machine's identifier. As a club member, the machine 100 may be recognized and any film sent in to be developed may then be automatically downloaded into the machine 100 in a seamless fashion (see FIG. 20).

Participating companies can develop the film and upload it directly to a special website using the machine's identifier. Thus, once the user communicates with the website, their machine searches an “Inbox” to determine if the film is there. If there is film in the box, an animated icon (e.g., a roll of film) notifies the user that his or her photos are ready. The user at that point can download his or her pictures by simply clicking on the icon. The user also has the option to view newly developed photos in a “click-through” slideshow, begin the music video making process and/or print individual photos.

Other services to be offered to club members may include: (i) burning onto DVDs; (ii) film developing—special offers; (iii) special printing—posters and more; (iv) photo restoration and/or enhancements; (v) media transfers; (vi) downloading software upgrades; and/or (vii) downloading themes, backgrounds, effects, and/or music.

Machine to Machine Communications

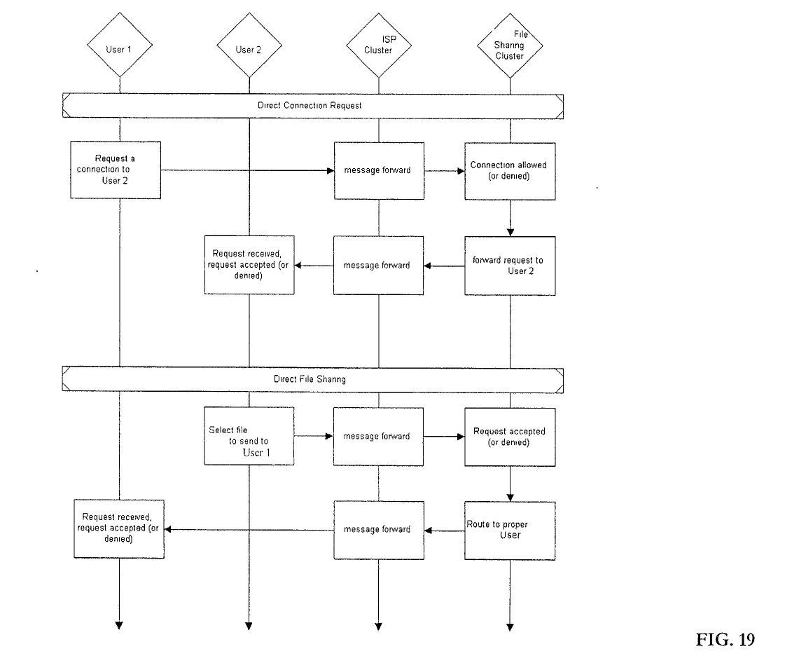

The user of the machine 100 may send, for example, photos and/or a music video(s) directly to another machine 100, for example, through network communications. Machine-to-machine communications (see FIG. 19) allows the creation of an exclusive community for consumers such as, for example, picture takers/enthusiast. A specialized and/or customized browser may enable access to this exclusive community.

Exclusive Community

The machine 100 may give the user access to an exclusive community 1710 (see FIG. 17). The user may connect to the exclusive community, for example, by hooking up the machine 100 to a telephone line and/or a high-speed Internet connection (e.g., cable modems, DSL, etc.). The machine 100 may automatically dial-up to an ISP via pre-configured programs. As such, the user may not need to worry about any dialing configurations. One illustrative advantage to connecting to a proprietary community is security. Since servers within the Exclusive Community can control how clients communicate and what they can access, security problems common with the Internet may be avoided. Users may thus purchase goods, send files, and communicate with others, through the exclusive community, without worrying about security issues.

ISP Cluster

The ISP Cluster includes servers that may allow users of the machine 100 to connect to the exclusive community. Users on dial-up and/or broadband connections may first be connected to the ISP Cluster. The ISP Cluster may then serve as the user's gateway by which other portions of the community are accessible. Internet connectivity outside of the Exclusive Community can be created using the ISP Cluster, for example, as the first point of access. Because dial-up clients may auto-connect to the ISP Cluster, for example, via a toll free number, automatic disconnections may take place after a set period of inactivity and/or after moving to an offline feature of the machine 100 (see FIG. 18), for example, so as to keep ISP costs down.

Users may communicate directly with other users of the machine 100, for example, after first connecting to the ISP Cluster. Once the connection has been established, instant messaging, file transfer, and even voice and video communications can take place between two machine users.

Store and Information Center

The machine 100 may access the store and information center by connecting to the exclusive community. The features of the store and information center may include: music video creating instructions, an online discount store, discounted products, software upgrades, additional theme and music downloads, informational broadcasts, and/or community chats. Users may also connect to the Internet through these servers, which may function as a secondary gateway to connect to the Internet.

Companion products can also be featured in the store and information center. Since the exclusive community may already have all shipping and billing information about each of its users, purchasing products can be done with a couple simple clicks instead of the lengthy process often required with e-commerce today. Further, this sensitive data may not be transmitted over a vulnerable, non-secure channel.

Photo Storage Center

Users of the machine 100 may store copies of their photographs and/or videos in a secure environment, namely, in the photo storage center. As a result, the users may no longer need to worry about their photos being susceptible to deterioration, theft, loss, and/or being destroyed as offsite redundant computers guarantee the safety of their photographs, for example. Additionally, the photo storage center may receive photographs from photo development companies, who may send photographs directly to the exclusive community (see above). Users may thus have access to their newly developed photographs as well as their backed up photographs.

Sharing Cluster

Users may upload their files to the sharing cluster so that they can be accessed by whomever they please. Files could be uploaded for public viewing and/or for private viewing by selected friends and family only. The users may upload their favorite music videos, photographs, music, themes, and more into this sharing cluster.

Theme Compilation/Compression

Themes may be downloaded from the online site at the exclusive community. Each theme may be downloaded in a single file for simplicity in file management, as well as for protecting raw file formats (see FIG. 15). A music file compressed into a proprietary format (see FIG. 16) makes it more difficult to be tampered with, as compared, for example, with mp3 files, which are easily shared.

All files that make up a theme may be compressed into one single theme file. It may have a custom file header that is proprietary to the machine 100. The header may not be published and/or readable by any machine other than the machine 100 itself. Once the machine 100 reads the header, it may display the details of the files compressed into the single theme file and/or map how each can be extracted and played. The files may be temporarily loaded into memory so that the machine 100 can use them, and may vanish upon the end of the machine's execution so to leave no trace of the original files.

Method to Effect a Presentation

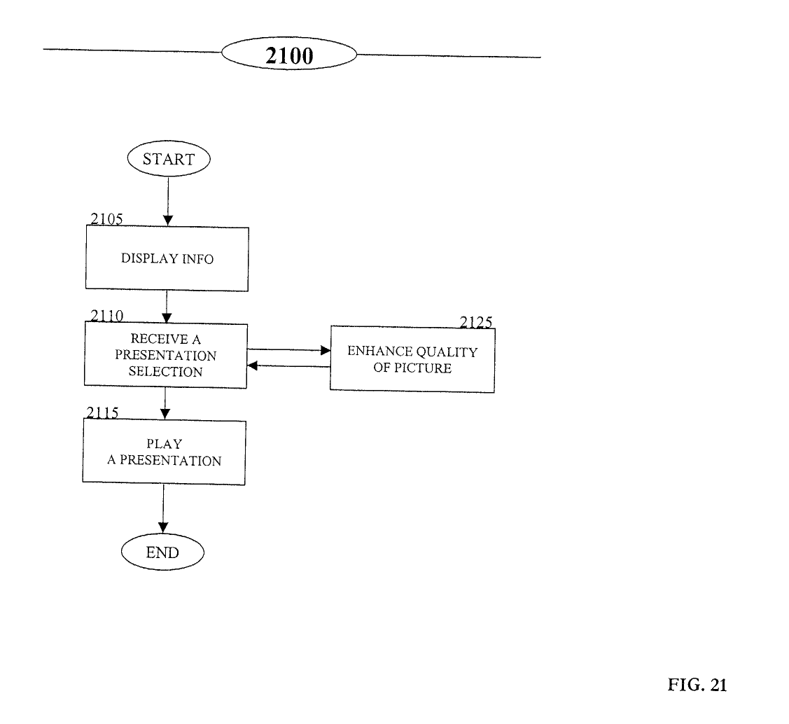

FIG. 21 illustrates one implementation for effecting a method 2100. In block 2105, the method 2100 displays, through a display device coupled to a machine 100, information identifying a presentation background, music, presentation effects, and/or a picture (e.g., a plurality of (motion) pictures). In block 2110, the method receives a presentation selection including information identifying (i) the presentation background, (ii) the music, (iii) the presentation effects, and/or (iv) the picture. In block 2115, the method 2100 plays, through the display device, a presentation reflecting the selected information.

The machine 100 includes a processor and a memory. The processor is constructed and arranged to effect the presentation. The memory is constructed and arranged to store information representing the picture, the presentation background, the music, the presentation effects, and/or the presentation. The memory may include up to 20 to 40 gigabytes or more of memory.

The machine 100 may also include a data storage drive unit and/or system (e.g., a hard drive), a printer unit and/or system, and/or a docking station unit and/or system. The machine 100 may further include a VCR, a DVD player, a CD player, a MP3 player, a DVD recorder, a CD recorder, and/or a MP3 recorder. The method 2100 may display, through the display device coupled to the machine 100, a Web browser (e.g., a selective Web site browser). The Web browser may reside in the machine 100.

The display device may be coupled, through the machine 100, to a network. In addition, the machine 100 may be coupled, through the display device, to the network. The display device may include a television, a monitor, a projector, a (handheld) music player and/or recorder, and/or a (handheld) video player and/or recorder. The machine 100 may communicate, through the network coupled to the machine 100, with a second machine. The network may include a private network, and the second machine may include a personal computer, a data storage drive, a printer, a docking station apparatus, etc. The private network may be a private network for users of the machine 100.

The presentation may include a picture presentation and/or a music video presentation. The presentation background may include a picture album background, a picture frame background, and/or a blank background. The presentation effects may include to (i) zoom, (ii) fade, (iii) flash, and/or (iv) kaleidoscope the presentation. The presentation may include a plurality of pages, and the presentation effects may include turning the pages. An association among the presentation background, the music, and the presentation effects may represent a presentation theme. The music may include a song, and the presentation background and/or the presentation effects may reflect a music video for the song.

The machine 100 may send and/or receive, through the network coupled to the machine 100, information representing the picture, the presentation background, the music, the presentation effects, and/or the presentation. The machine 100 may receive, through a camera coupled to the machine 100, information representing the picture. The machine 100 may include a camera docking structure to dock the camera to the machine 100.

The method 2100 may scan, through the machine 100, the picture to produce the information representing the picture. In block 2125, the method 2100 may enhance the displaying quality of the information representing the picture in response to a single action. The single action is to (i) press a first button, (ii) click a second button, and/or (iii) touch the display device.

The method 2100 may display, through the display device, a graphical user interface. The graphical user interface may include information identifying the picture, the presentation background, the music, and/or the presentation effects. The graphical user interface may also include an indication to (i) edit, (ii) play, and/or (iii) store the presentation. The graphical user interface may be the only graphical user interface available to be displayed. The graphical user interface may be displayed in response to (i) pressing a first button, (ii) clicking a second button, (iii) speaking a sound, and/or (iv) touching the display device.

The machine 100 may be assigned an identifier, and may send, through the network, the identifier to a second machine. Also, the machine 100 may send, through the network, a request to order information representing music (e.g., a song). The machine 100 may receive, through the network, information identifying and/or representing the picture, the presentation background, the music, and/or the presentation effects in response to the sent identifier and/or the sent request. The machine 100 may send, through the network, the identifier to the second machine in response to powering up the machine 100. The identifier may be used to identify a user of the machine 100.

Method to Send a Presentation Theme

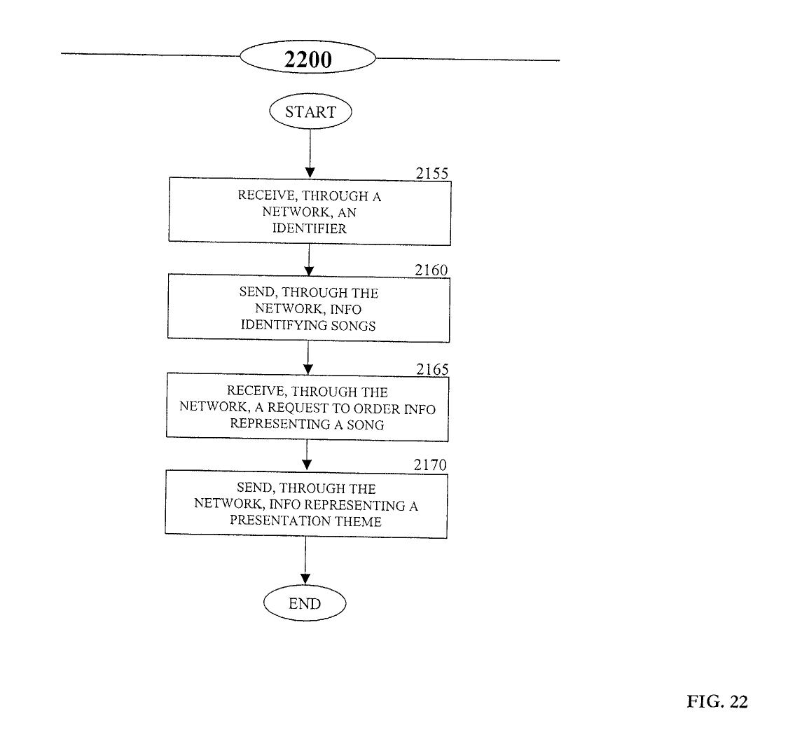

FIG. 22 illustrates one implementation of a method 2200, for example, to send a presentation theme to a user of a machine 100. In block 2155, the method 2200 receives, through a network, an identifier from a machine 100. In block 2160, the method 2200, in response to the received identifier, sends, through the network, information identifying a plurality of songs to the machine 100. In block 2165, the method 2200 receives, through the network, a request, from the machine 100, to order information representing a song. In block 2170, the method 200, in response to the received order, sends, through the network, information representing, for example, the song and/or a presentation theme to the machine 100. The presentation theme may be sent, through the network, to the machine 100 to effect a music video presentation (see, for example, above discussion). The network (see also, for example, above discussion) may be a private network for users of the machine 100.

The identifier may be used to identify the machine 100, and/or a user of the machine 100. The presentation theme may include information representing the song (e.g., a complete song), a presentation background and/or presentation effects. The presentation theme may reflect an association (e.g., predetermined association) among the song, the presentation background and the presentation effects. The presentation background and/or the presentation effects may reflect a music video (e.g., an MTV video) for the song.

Presentation themes, from artists such as, for example, Jennifer Lopez, Britney Spears, and Ricky Martin, may then be ordered (directly, and/or indirectly through the purchase of music) to be downloaded into the machine 100, and to be available for immediate user selection. The user of the machine 100 may then simply scan and/or select his or her photos, select the sent presentation theme and press play to star with his or her superstar idol(s) in a dynamic music video.

Apparatus to Effect a Presentation

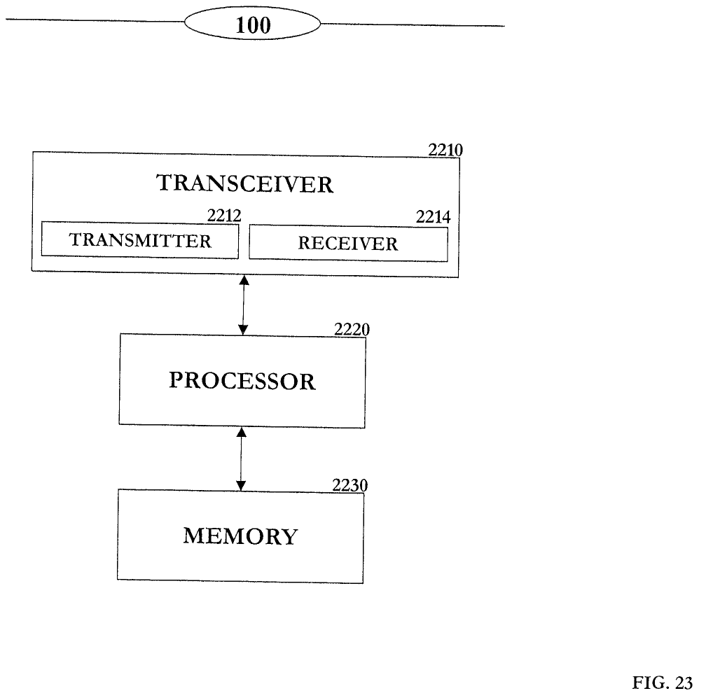

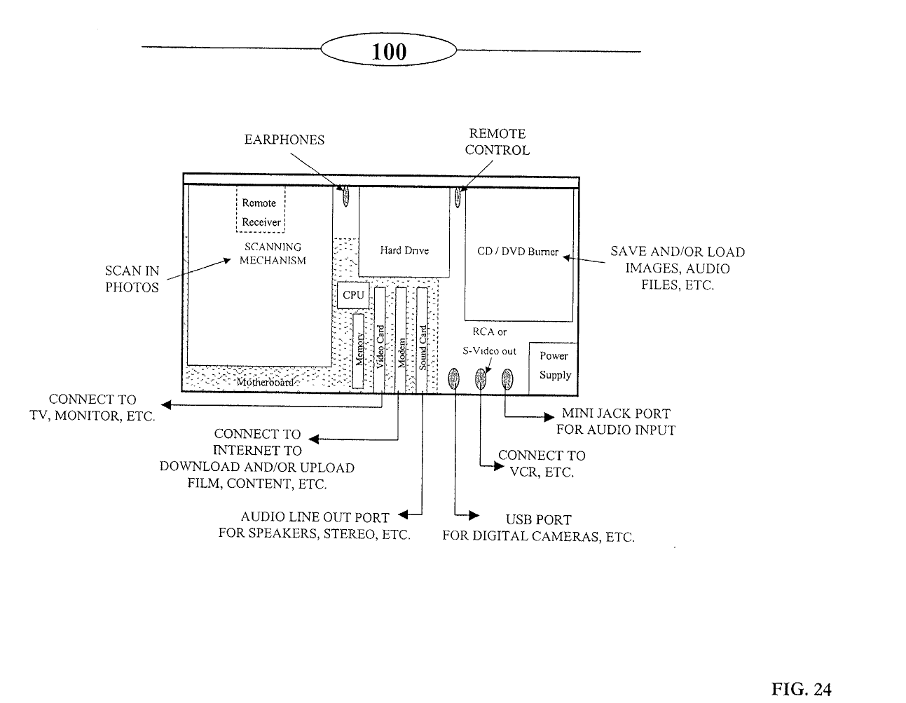

FIG. 23 illustrates one implementation of a machine (e.g., a machine 100), whereas FIG. 24 illustrates another implementation of the machine. The machine 100 may be constructed and arranged to effect a presentation (e.g., method 2100) and/or send a presentation theme (e.g., method 2200).

The machine 100 may include (i) a data storage drive unit and/or system (e.g., a multimedia data storage drive such as, for example, a multimedia hard drive), (ii) a printer unit and/or system (e.g., a multimedia printer), and/or (iii) a docking station unit and/or system (e.g., a multimedia docking station). The (multimedia) data storage drive, the (multimedia) printer, and/or the (multimedia) docking station may include a data storage drive, a printer, a docking station, and/or a display device (e.g., a (handheld) music player and/or recorder, and/or a (handheld) video player and/or recorder).

The machine 100 may also comprise a transceiver 2210, a processor 2220, and a memory 2230. In addition, the machine 100 may comprise a document scanning mechanism (see FIG. 24). The transceiver 2210 includes a transmitter 2212 that allows the machine 100 to transmit information, for example, to a network (not shown) over a communications link (not shown). The network may include a wide area network (WAN) (e.g., Internet), or a local area network (LAN) (e.g., Intranet), or the like, where the communications link may be a direct land line, or a radio communications link, such as a microwave link, satellite link, or the like. The transceiver 2210 also includes a receiver 2214 that allows the machine 100 to receive information, for example, from the network over the communications link. Such transmission and reception operations over the communications link may be conducted using the same or different data rates, communications protocols, carrier frequencies, and/or modulation schemes. Likewise, the operations and/or circuit configurations of the transmitter 2212 and the receiver 2214, respectively, may be completely independent of one another or, alternatively, may be partially or fully integrated. The document scanning mechanism 2240 allows the machine 100 to produce (digital) information representing a (printed) document such as, for example, a picture. The printer (not shown), on the other hand, allows the machine 100 to produce a (printed) document of all or part of the presentation.

The processor 2220, which may comprise one or more microprocessors, microcontrollers, or other arrays of logic elements, controls the operation of the machine 100 according to a sequence of commands that may be (i) stored in the memory 2230 or in another storage device within or coupled to the machine 100, (ii) entered by a user through an interface such as a data entry device (e.g., a keypad) (not shown), and/or (iii) received from the network over the communications link.

The memory 2230, which may comprise read-only memory (ROM), random-access memory (RAM), nonvolatile memory, an optical disk, a magnetic tape, and/or magnetic disk, stores programmable parameters and may also store information including executable instructions, non-programmable parameters, and/or other data. For example, an identifier of the machine 100 may be stored in the memory 2230 and/or may be stored elsewhere within the machine 100. The memory 2230 may be within and/or coupled to the machine 100. Executable instructions defining a method associated with the presented embodiments may also be stored in the memory 2230 for execution by the processor 2220. The method may be programmed when the machine 100 is manufactured or via a machine-readable medium at a later date. Such a medium may include any of the forms listed above with respect to the memory 2230 and may further include, for example, a carrier wave modulated, or otherwise manipulated, to convey instructions that can be read, demodulated/decoded and executed by the machine 100.

In sum, one embodiment of the machine 100, unlike presently known systems, allows a user to store and/or display print and/or digital photographs. Second, the machine 100 allows the user to (directly) connect the machine 100 to a display device such as, for example, a television to display photographs and/or play music videos. Third, the machine 100 allows for processed film to be downloaded (directly) into the machine 100. Fourth, the machine 100 provides for machine-to-machine communications, for example, to allow the user to send photographs and/or music videos (directly) to friends and/or family. Fifth, a plurality of machines 100, coupled to a private network, comprise a private community of consumers that allow any and all users of the machines 100 to share information, buy products, participate in promotional opportunities, etc. Sixth, the machine 100 may also be: (i) an (portable) organizer and/or player of photographs and/or music videos, (ii) a CD player, (iii) a MP3 player, (iv) a DVD player, (v) a karaoke machine, (vi) a business presentation machine, (vii) a photo enhancer, (viii) a storage device for photographs, (ix) a Web browser (e.g., a selective Web site browser), (x) a printer, (xi) a docking station, and/or (xii) a data storage drive. Seventh, the machine 100 may be (solely) dedicated to produce music videos.

In view of the foregoing, it will be apparent to one of ordinary skill in the art that the described embodiments may be implemented in software, firmware, and/or hardware. The actual software code or specialized control hardware used to implement the present invention is not limiting of the invention. Thus, the operation and behavior of the embodiments is described without specific reference to the actual software code or specialized hardware components. The absence of such specific references is feasible because it is clearly understood that artisans of ordinary skill would be able to design software and/or control hardware to implement the embodiments of the present invention based on the description herein.

The foregoing presentation of the described embodiments is provided to enable any person skilled in the art to make or use the present invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, or as a firmware program loaded into non-volatile memory or a software program loaded from or into a data storage medium as machine-readable code, such code being instructions executable by an array of logic elements such as a microprocessor or other digital signal processing unit, or some other programmable machine or system. As such, the present invention is not intended to be limited to the embodiments shown above, any particular sequence of instructions, and/or any particular configuration of hardware but rather is to be accorded the widest scope consistent with the principles and novel features disclosed in any fashion herein.

What is claimed is:

1. A method comprising:
displaying, through a display device connected to a machine, information identifying a presentation background, music, and presentation effects;
receiving a presentation selection including information identifying at least one of the presentation background, the music, and the presentation effects; and
playing, through the display device, a presentation reflecting the selected information,
wherein the machine is one of (i) a data storage drive, (ii) a printer, and (iii) a docking station, and includes a processor and a memory,
wherein the processor is constructed and arranged to effect the presentation, and
wherein the memory is constructed and arranged to store information representing the presentation background, the music, the presentation effects, and the presentation.

2. The method of claim 1, further comprising
displaying, through the display device, information identifying a picture,
wherein the presentation selection includes information identifying the picture, the presentation background, the music, and the presentation effects, and
wherein the memory is constructed and arranged to store information representing the picture, the presentation background, the music, the presentation effects, and the presentation.

3. The method of claim 2, wherein an association among the presentation background, the music, and the presentation effects represents a presentation theme.

4. The method of claim 2, wherein the machine is constructed and arranged (i) to receive, through a network coupled to the machine, information representing at least one of the picture, the presentation background, the music, and the presentation effects from a second machine, and (ii) to receive, through a camera coupled to the machine, information representing the picture.

5. The method of claim 2, further comprising
enhancing the displaying quality of the information representing the picture in response to a single action.

6. The method of claim 5, wherein the single action is at least one of to (i) press a first button, (ii) click a second button, and (iii) touch the display device.

7. The method of claim 1, wherein the presentation background includes at least one of a picture album background, a picture frame background, and a blank background.

8. The method of claim 1, wherein the music includes a song.

9. The method of claim 1, wherein the presentation effects includes at least one of to (i) zoom, (ii) fade, (iii) flash, and (iv) kaleidoscope the presentation.

10. The method of claim 1,
wherein the presentation includes a plurality of pages, and
wherein the presentation effects includes turning the pages.

11. The method of claim 1, wherein the display device is coupled, through the machine, to a network.

12. The method of claim 1, wherein the presentation includes a picture presentation.

13. The method of claim 1, wherein the presentation includes a music video presentation.

14. The method of claim 1, wherein the display device includes a television.

15. The method of claim 1, wherein the display device includes at least one of a monitor and a projector.

16. The method of claim 1, wherein the machine is assigned an identifier, and is constructed and arranged to send, through a network coupled to the machine, the identifier to a second machine.

17. The method of claim 16, wherein the machine is constructed and arranged to receive, through the network, information representing at least one of a picture, the presentation background, the music, and the presentation effects in response to the sent identifier.

18. The method of claim 16, wherein the machine is constructed and arranged to send, through the network, the identifier to the second machine in response to powering up the machine.

19. The method of claim 16, wherein the identifier is used to identify a user of the machine.

20. The method of claim 1,
wherein the first mentioned machine is constructed and arranged to communicate, through a network coupled to the machine, with a second machine, and
wherein the network includes a private network.

21. The method of claim 20, wherein the private network is constructed and arranged to be a private network for users of the first mentioned machine.

22. A method comprising:
displaying, through a display device connected to a machine, information identifying a picture, and a presentation background;
receiving a presentation selection including information identifying at least one of (i) the picture, and (ii) the presentation background; and
playing, through the display device, a presentation reflecting the selected information,
wherein the machine is one of (i) a data storage drive, (ii) a printer, and (iii) a docking station, and includes a processor and a memory,
wherein the processor is constructed and arranged to effect the presentation,
wherein the memory is constructed and arranged to store information representing the picture, the presentation background, and the presentation, and
wherein the display device is coupled, through the machine, to a network.

23. The method of claim 22, wherein the presentation background includes at least one of a picture album background, a picture frame background, and a blank background.

24. The method of claim 22, wherein the display device includes a television.

25. The method of claim 22, wherein the network is constructed and arranged to be a private network for users of the machine.

26. The method of claim 22, wherein the machine is constructed and arranged to receive, through a camera coupled to the machine, information representing the picture.

27. A machine-readable medium having encoded information, which when read and executed by a machine causes a method comprising:
displaying, through a display device connected to the machine, information identifying a presentation background, music, and presentation effects;
receiving a presentation selection including information identifying at least one of the presentation background, the music, and the presentation effects; and
playing, through the display device, a presentation reflecting the selected information,
wherein the machine is one of (i) a data storage drive, (ii) a printer, and (iii) a docking station, and includes a processor and a memory,
wherein the processor is constructed and arranged to effect the presentation, and
wherein the memory is constructed and arranged to store information representing the presentation background, the music, the presentation effects, and the presentation.

28. The machine-readable medium of claim 27, the method further comprising
displaying, through the display device, information identifying a picture,
wherein the presentation selection includes information identifying the picture, the presentation background, the music, and the presentation effects, and
wherein the memory is constructed and arranged to store information representing the picture, the presentation background, the music, the presentation effects, and the presentation.

29. The machine-readable medium of claim 28, wherein an association among the presentation background, the music, and the presentation effects represents a presentation theme.

30. The machine-readable medium of claim 28, wherein the machine is constructed and arranged (i) to receive, through a network coupled to the machine, information representing at least one of the picture, the presentation background, the music, and the presentation effects from a second machine, and (ii) to receive, through a camera coupled to the machine, information representing the picture.

31. The machine-readable medium of claim 28, the method further comprising
enhancing the displaying quality of the information representing the picture in response to a single action.

32. The machine-readable medium of claim 31, wherein the single action is at least one of to (i) press a first button, (ii) click a second button, and (iii) touch the display device.

33. The machine-readable medium of claim 27, wherein the presentation background includes at least one of a picture album background, a picture frame background, and a blank background.

34. The machine-readable medium of claim 27, wherein the music includes a song.

35. The machine-readable medium of claim 27, wherein the presentation effects includes at least one of to (i) zoom, (ii) fade, (iii) flash, and (iv) kaleidoscope the presentation.

36. The machine-readable medium of claim 27,
wherein the presentation includes a plurality of pages, and
wherein the presentation effects includes turning the pages.

37. The machine-readable medium of claim 27, wherein the display device is coupled, through the machine, to a network.

38. The machine-readable medium of claim 27, wherein the presentation includes a picture presentation.

39. The machine-readable medium of claim 27, wherein the presentation includes a music video presentation.

40. The machine-readable medium of claim 27, wherein the display device includes a television.

41. The machine-readable medium of claim 27, wherein the display device includes at least one of a monitor and a projector.

42. The machine-readable medium of claim 27, wherein the machine is assigned an identifier, and is constructed and arranged to send, through a network coupled to the machine, the identifier to a second machine.

43. The machine-readable medium of claim 42, wherein the machine is constructed and arranged to receive, through the network, information representing at least one of a picture, the presentation background, the music, and the presentation effects in response to the sent identifier.

44. The machine-readable medium of claim 42, wherein the machine is constructed and arranged to send, through the network, the identifier to the second machine in response to powering up the machine.

45. The machine-readable medium of claim 42, wherein the identifier is used to identify a user of the machine.

46. The machine-readable medium of claim 27,
wherein the first mentioned machine is constructed and arranged to communicate, through a network coupled to the machine, with a second machine, and
wherein the network includes a private network.

47. The machine-readable medium of claim 46, wherein the private network is constructed and arranged to be a private network for users of the first mentioned machine.

48. A machine-readable medium having encoded information, which when read and executed by a machine causes a method comprising:
displaying, through a display device connected to the machine, information identifying a picture, and a presentation background;
receiving a presentation selection including information identifying at least one of (i) the picture, and (ii) the presentation background; and
playing, through the display device, a presentation reflecting the selected information,
wherein the machine is one of (i) a data storage drive, (ii) a printer, and (iii) a docking station, and includes a processor and a memory,
wherein the processor is constructed and arranged to effect the presentation,
wherein the memory is constructed and arranged to store information representing the picture, the presentation background, and the presentation, and
wherein the display device is coupled, through the machine, to a network.

49. The machine-readable medium of claim 48, wherein the presentation background includes at least one of a picture album background, a picture frame background, and a blank background.

50. The machine-readable medium of claim 48, wherein the display device includes a television.

51. The machine-readable medium of claim 48, wherein the network is constructed and arranged to be a private network for users of the machine.

52. The machine-readable medium of claim 48, wherein the machine is constructed and arranged to receive, through a camera coupled to the machine, information representing the picture.

53. A data storage drive comprising:
a transmitter to send to a display device information identifying a presentation background, music, and presentation effects;
a receiver to receive a presentation selection including information identifying at least one of the presentation background, the music, and the presentation effects;
a processor, coupled to the transmitter and the receiver, to effect a presentation reflecting the selected information; and
a memory, coupled to the processor, to store information representing the presentation background, the music, the presentation effects, and the presentation,
wherein the data storage drive is constructed and arranged to be connected to the display device.

54. The data storage drive of claim 53,
wherein the transmitter is constructed and arranged to send to the display device information identifying a picture,
wherein the presentation selection includes information identifying the picture, the presentation background, the music, and the presentation effects, and
wherein the memory is constructed and arranged to store information representing the picture, the presentation background, the music, the presentation effects, and the presentation.

55. The data storage drive of claim 54, wherein an association among the presentation background, the music, and the presentation effects represents a presentation theme.

56. The data storage drive of claim 54, wherein the data storage drive is constructed and arranged (i) to receive, through a network coupled to the data storage drive, information representing at least one of the picture, the presentation background, the music, and the presentation effects from a second machine, and (ii) to receive, through a camera coupled to the data storage drive, information representing the picture.

57. The data storage drive of claim 54, wherein the displaying quality of the information representing the picture is enhanced in response to a single action.

58. The data storage drive of claim 57, wherein the single action is at least one of to (i) press a first button, (ii) click a second button, and (iii) touch the display device.

59. The data storage drive of claim 53, wherein the display device is coupled, through the data storage drive, to a network.

60. The data storage drive of claim 53, wherein the presentation includes a picture presentation.

61. The data storage drive of claim 53, wherein the presentation includes a music video presentation.

62. The data storage drive of claim 53, wherein the display device includes a television.

63. The data storage drive of claim 53, wherein the data storage drive is assigned an identifier, and is constructed and arranged to send, through a network coupled to the data storage drive, the identifier to a second machine.

64. The data storage drive of claim 63, wherein the data storage drive is constructed and arranged to receive, through the network, information representing at least one of a picture, the presentation background, the music, and the presentation effects in response to the sent identifier.

65. The data storage drive of claim 63, wherein the data storage drive is constructed and arranged to send, through the network, the identifier to the second machine in response to powering up the data storage drive.

66. The data storage drive of claim 63, wherein the identifier is used to identify a user of the data storage drive.

67. The data storage drive of claim 53,
wherein the data storage drive is constructed and arranged to communicate, through a network coupled to the data storage drive; with a second machine, and
wherein the network includes a private network.

68. The data storage drive of claim 67, wherein the private network is constructed and arranged to be a private network for users of the data storage drive.

69. A data storage drive comprising:
a transmitter to send to a display device information identifying a picture, and a presentation background;
a receiver to receive a presentation selection including information identifying at least one of (i) the picture, and (ii) the presentation background;
a processor, coupled to the transmitter and the receiver, to effect a presentation reflecting the selected information; and
a memory, coupled to the processor, to store information representing the picture, the presentation background, and the presentation,
wherein the data storage drive is constructed and arranged to be connected to the display device, and
wherein the display device is coupled, through the data storage drive, to a network.

70. The data storage drive of claim 69, wherein the display device includes a television.

71. The data storage drive of claim 69, wherein the network is constructed and arranged to be a private network for users of the data storage drive.

72. The data storage drive of claim 69, wherein the data storage drive is constructed and arranged to receive, through a camera coupled to the data storage drive, information representing the picture.

73. A printer comprising:
a transmitter to send to a display device information identifying a presentation background, music, and presentation effects;
a receiver to receive a presentation selection including information identifying at least one of the presentation background, the music, and the presentation effects;
a processor, coupled to the transmitter and the receiver, to effect a presentation reflecting the selected information; and
a memory, coupled to the processor, to store information representing the presentation background, the music, the presentation effects, and the presentation,
wherein the printer is constructed and arranged to be connected to the display device.

74. The printer of claim 73,
wherein the transmitter is constructed and arranged to send to the display device information identifying a picture,
wherein the presentation selection includes information identifying the picture, the presentation background, the music, and the presentation effects, and
wherein the memory is constructed and arranged to store information representing the picture, the presentation background, the music, the presentation effects, and the presentation.

75. The printer of claim 74, wherein an association among the presentation background, the music, and the presentation effects represents a presentation theme.

76. The printer of claim 74, wherein the printer is constructed and arranged (i) to receive, through a network coupled to the printer, information representing at least one of the picture, the presentation background, the music, and the presentation effects from a second machine, and (ii) to receive, through a camera coupled to the printer, information representing the picture.

77. The printer of claim 74, wherein the displaying quality of the information representing the picture is enhanced in response to a single action.

78. The printer of claim 77, wherein the single action is at least one of to (i) press a first button, (ii) click a second button, and (iii) touch the display device.

79. The printer of claim 73, wherein the display device is coupled, through the printer, to a network.

80. The printer of claim 73, wherein the presentation includes a picture presentation.

81. The printer of claim 73, wherein the presentation includes a music video presentation.

82. The printer of claim 73, wherein the display device includes a television.

83. The printer of claim 73, wherein the printer is assigned an identifier, and is constructed and arranged to send, through a network coupled to the printer, the identifier to a second machine.

84. The printer of claim 83, wherein the printer is constructed and arranged to receive, through the network, information representing at least one of a picture, the presentation background, the music, and the presentation effects in response to the sent identifier.

85. The printer of claim 83, wherein the printer is constructed and arranged to send, through the network, the identifier to the second machine in response to powering up the printer.

86. The printer of claim 83, wherein the identifier is used to identify a user of the printer.

87. The printer of claim 73,
wherein the printer is constructed and arranged to communicate, through a network coupled to the printer, with a second machine, and
wherein the network includes a private network.

88. The printer of claim 87, wherein the private network is constructed and arranged to be a private network for users of the printer.

89. A printer comprising:
a transmitter to send to a display device information identifying a picture, and a presentation background;
a receiver to receive a presentation selection including information identifying at least one of (i) the picture, and (ii) the presentation background;
a processor, coupled to the transmitter and the receiver, to effect a presentation reflecting the selected information; and
a memory, coupled to the processor, to store information representing the picture, the presentation background, and the presentation,
wherein the printer is constructed and arranged to be connected to the display device, and
wherein the display device is coupled, through the printer, to a network.

90. The printer of claim 89, wherein the display device includes a television.

91. The printer of claim 89, wherein the network is constructed and arranged to be a private network for users of the printer.

92. The printer of claim 89, wherein the printer is constructed and arranged to receive, through a camera coupled to the printer, information representing the picture.

93. A docking station comprising:
a transmitter to send to a display device information identifying a presentation background, music, and presentation effects;
a receiver to receive a presentation selection including information identifying at least one of the presentation background, the music, and the presentation effects;
a processor, coupled to the transmitter and the receiver, to effect a presentation reflecting the selected information; and
a memory, coupled to the processor, to store information representing the presentation background, the music, the presentation effects, and the presentation,
wherein the docking station is constructed and arranged to be connected to the display device.

94. The docking station of claim 93,
wherein the transmitter is constructed and arranged to send to the display device information identifying a picture,
wherein the presentation selection includes information identifying the picture, the presentation background, the music, and the presentation effects, and
wherein the memory is constructed and arranged to store information representing the picture, the presentation background, the music, the presentation effects, and the presentation.

95. The docking station of claim 94, wherein an association among the presentation background, the music, and the presentation effects represents a presentation theme.

96. The docking station of claim 94, wherein the docking station is constructed and arranged (i) to receive, through a network coupled to the docking station, information representing at least one of the picture, the presentation background, the music, and the presentation effects from a second machine, and (ii) to receive, through a camera coupled to the docking station, information representing the picture.

97. The docking station of claim 94, wherein the displaying quality of the information representing the picture is enhanced in response to a single action.

98. The docking station of claim 97, wherein the single action is at least one of to (i) press a first button, (ii) click a second button, and (iii) touch the display device.

99. The docking station of claim 93, wherein the display device is coupled, through the docking station, to a network.

100. The docking station of claim 93, wherein the presentation includes a picture presentation.

101. The docking station of claim 93, wherein the presentation includes a music video presentation.

102. The docking station of claim 93, wherein the display device includes a television.

103. The docking station of claim 93, wherein the docking station is assigned an identifier, and is constructed and arranged to send, through a network coupled to the docking station, the identifier to a second machine.

104. The docking station of claim 103, wherein the docking station is constructed and arranged to receive, through the network, information representing at least one of a picture, the presentation background, the music, and the presentation effects in response to the sent identifier.

105. The docking station of claim 103, wherein the docking station is constructed and arranged to send, through the network, the identifier to the second machine in response to powering up the docking station.

106. The docking station of claim 103, wherein the identifier is used to identify a user of the docking station.

107. The docking station of claim 93,
wherein the docking station is constructed and arranged to communicate, through a network coupled to the docking station, with a second machine, and
wherein the network includes a private network.

108. The docking station of claim 107, wherein the private network is constructed and arranged to be a private network for users of the docking station.

109. A docking station comprising:
a transmitter to send to a display device information identifying a picture, and a presentation background;
a receiver to receive a presentation selection including information identifying at least one of (i) the picture, and (ii) the presentation background;
a processor, coupled to the transmitter and the receiver, to effect a presentation reflecting the selected information; and
a memory, coupled to the processor, to store information representing the picture, the presentation background, and the presentation,
wherein the docking station is constructed and arranged to be connected to the display device, and
wherein the display device is coupled, through the docking station, to a network.

110. The docking station of claim 109, wherein the display device includes a television.

111. The docking station of claim 109, wherein the network is constructed and arranged to be a private network for users of the docking station.

112. The docking station of claim 109, wherein the docking station is constructed and arranged to receive, through a camera coupled to the docking station, information representing the picture.
